(19) United States
(12) Patent Application Publication
(10) Pub. No.: US 2026/0357755 A1
(43) Pub. Date: Nov. 12, 2026

(54) METHOD FOR MANAGING POWER TRANSITIONS BETWEEN GENERATION MODES

(71) Applicant: SAFRAN, Paris (FR)

(72) Inventors: Meriem ABDELLATIF, Moissy-Cramayel (FR); Florent Jean-Arnaud ROUGIER, Moissy-Cramayel (FR); Guillaume François Daniel BIDAN, Moissy-Cramayel (FR); Anne Marie LIENHARDT, Moissy-Cramayel (FR)

(73) Assignee: SAFRAN, Paris (FR)

(21) Appl. No.: 19/139,161

(22) PCT Filed: Dec. 14, 2023
(86) PCT No.: PCT/FR2023/052014

§ 371 Date: Jun. 13, 2025

(30) Foreign Application Priority Data
Dec. 16, 2022 (FR) FR2213646

(51) Int. Cl. F02C 9/00

(52) U.S. Cl. CPC F02C 9/00; F05D 2270/053; F05D 2270/70

(57) ABSTRACT

Method for managing power transitions between a first generation mode and a second generation mode in a turbine engine having a high-pressure shaft from which high-pressure power is withdrawn and a low-pressure shaft from which low-pressure power is withdrawn, the first generation mode corresponding to a first power sharing between the high-pressure power and the low-pressure power and the second generation mode corresponding to a second power sharing between the high-pressure power and the low-pressure power, the sum of the high- and low-pressure powers withdrawn in each generation mode defining the same total power, the transition between the first generation mode and the second generation mode occurring during a predetermined period (t₂-t₁) while applying the same smoothing function f(t) both to the high-pressure power and to the low-pressure power and without modification of the total power.

### TECHNICAL FIELD

The present invention relates to the field of the internal hybridization of more-electric or highly electric aircraft turbomachines.

### PRIOR ART

Climate change is a major concern for many legislating and regulating bodies throughout the world. Indeed, various restrictions on carbon emissions have been or will be adopted by various states. In particular, an ambitious standard is applied both to new types of aircraft but also those currently in circulation, requiring the implementation of technological solutions in order to make them conform to regulations in force. Civil aviation has mobilized itself for several years now to provide a contribution to the struggle against climate change.

Technological research efforts have already allowed very significant improvement in the environmental performance of aircraft. The Applicant takes into consideration the impacting factors in all the phases of design and of development to obtain aeronautical components and products with lower energy consumption, more respectful of the environment and the integration and use of which in civil aviation have moderate environmental impacts, for the purpose of improving the energy efficiency of these aircraft.

As a consequence, the Applicant works continuously on reducing its climatic impact by using methods and exploiting virtual development and fabrication methods and minimizing the emission of greenhouse gases to the minimum possible to reduce the environmental footprint of its activity.

This sustained research and development work apply both to new generations of aircraft turbine engines, lightening machinery, particularly through the materials employed and lightened on-board equipment, development of the use of electrical technologies to provide propulsion and, indispensable complements to technological progress, aeronautical biofuels.

Turbine engine hybridization is accomplished by an electrical system forming an interface between the mechanical shafts of the turbine engine and the electrical network of the aircraft.

This system must allow ensuring the functions of starting the turbine engine (HP and/or LP), the generation of controlled electrical power for feeding the propulsive and non-propulsive loads, and the controlled injection or withdrawal of power from the shafts of the turbine engine to assist it if necessary. The balance between the power consumed by the loads and the power generated by the available sources is provided by controlling the bus voltage (in frequency and in maximum amplitude for AC voltage, and in amplitude for DC voltage), while respecting the constraints of the system.

Conventionally, and as illustrated in FIG. 9, the architectures of the internal hybridization systems of a turbine engine 100 are based on DC channels connected in parallel, typically an HP channel (corresponding to the high-pressure shaft 102 of the turbine engine) and an LP channel (corresponding to its low-pressure shaft 104). Each of these two DC channels is embodied by an electrical machine 106, 108, typically a synchronous permanent-magnet machine, associated with a controlled reversible AC/DC power converter 110, 112 delivering direct voltage to a DC buss 114 connected to the (propulsive and/or non-propulsive) loads 116 to be fed. The control of the reversible power converters is conventionally provided by a control module 118 which receives its orders from the controller of the turbine engine ECU 120 (for “Electronic Control Unit”).

An external source, typically a set of batteries or super-capacitors, associated with a reversible DC/DC converter (the set not being illustrated) can also be connected in parallel with these HP and LP channels to supply power to the HP and/or LP shafts, for example during starting of the turbine engine.

The generation of power from the HP and LP shafts of the turbine engine has a different impact on its performance (operability) or the thrust that it generates depending on the shaft from which the withdrawal is obtained. The controller of the turbine engine therefore has the function in particular of adapting the percentages of participation of the electric machines to this power generation during the mission to optimize its operating point. To this end, the ECU 120 will ask the control module 118 to share the withdrawn powers between the HP and LP shafts for feeding the loads 116 of the network which generally have dynamic behavior that can be variable, particularly so-called active loads.

As shown in FIG. 10, this sharing of the withdrawn powers between the HP and LP shafts required by the ECU can, over the duration of a mission, vary according to several successive modes, such as a first generation mode in which 60% of the power is withdrawn from the HP shaft and 40% of the power is withdrawn from the LP shaft, and a second generation mode in which 100% of the power is withdrawn from the LP shaft, as illustrated. However, when changing the generation mode (at t₀), due to the instantaneous change of the power ratio, withdrawal impacts are created on each shaft of the turbine engine, the transients of which induce perturbations in the regulation of the turbine engine of such a nature as to cause a rejection of slow perturbations (typically<1 Hz). The impact on the mechanical shaft can also excite undesired mechanical modes.

Document US 20220371532 proposes an electrical system comprising a first electrical machine coupled to a first gas turbine and a second electrical machine coupled to a second gas turbine.

### DISCLOSURE OF THE INVENTION

To this end, the invention is the result of technological research intended to very significantly improve the performance of aircraft and, in this sense, contribute to the reduction of the environmental impact of these aircraft. To this end, the present invention therefore has as a main object to limit the impacts of power withdrawals when there is a change in the generation mode, while respecting the quality constraints of the electrical network. Another goal is to allow managing a possible load impact during this generation mode change.

These goals are achieved by a method for managing power transitions between a first generation mode and a second generation mode in a turbine engine having a high-pressure shaft from which high-pressure power is withdrawn, and a low-pressure shaft from which low-pressure power is withdrawn, the first generation mode corresponding to a first power sharing between the high-pressure power and the low-pressure power, and the second generation mode corresponding to a second power sharing, different from the first, between the high-pressure power and the low-pressure power, the sum of the high and low pressure powers withdrawn in each generation mode defining the same total power, characterized in that the transition between the first generation mode and the second generation mode occurs during a predetermined period (t₂-t₁) without modification of the total power and while applying the same smoothing function f(t) to the withdrawal of both the high-pressure power and the low-pressure power.

Thus, by ensuring smoothing of the withdrawn powers setpoint during generation, the regulation of the turbine engine is not perturbed and there is no need to complain about undesired excitation of mechanical modes. Respect of the quality of the electrical network is ensured because there is no modification of the total power.

Preferably, the smoothing function f(t) is a continuous or discrete bounded [0; 1] monotonic function with f(t₁)=0 and f(t₂)=1, typically a linear function f(t)=Kt, K being a proportionality factor, or a first-order function of the f(t)=1−exp (−t/tau) type, tau being a time constant.

Advantageously, the predetermined duration is comprised between 1 and 10 seconds.

Preferably, when a load impact corresponding to an additional withdrawal of power occurs during the transition, this additional withdrawal is carried out at the moment of the impact according to the first power sharing or according to the second power sharing, the smoothing function f(t) remaining applied upstream of this moment from a beginning of the transition and downstream of this moment until an end of the transition.

According to the embodiment considered, the additional withdrawal of power is carried out from each of the high- or low-pressure shafts according to the first power sharing and satisfies the following equation:
P=(1−ƒ(t))*P₀(t)+ƒ(t)*P₁(t), or even is carried out from each of the high- or low-pressure shafts according to the second power sharing and satisfies the following equation:
P=(1−ƒ(t)*P₀(t₁)+ƒ(t)*P₁(t₁)+P₁(t)−P₁(t₁) P₀ being the power required in the first generation mode, P₁ the power required in the second generation mode and t₁ the time of the mode change.

The invention also relates to a turbine engine (typically an aeronautical turbine engine such as a hybrid turbofan, a hybrid turboprop or a hybrid helicopter turbine engine) implementing the aforementioned method.

More particularly, the turbine engine can also comprise an adapter module configured to generate the smoothing function and arranged between a control module receiving power setpoints from an ECU and power converters associated with electrical machines mounted on the high- and low-pressure shafts.

### BRIEF DESCRIPTION OF THE DRAWINGS

Other features and advantages of the present invention will be revealed by the description given below, with reference to the appended drawings which illustrate one embodiment of it, devoid of any limiting character, and in which:

FIG. 1 illustrates an architecture of an internal hybridization system of a turbine engine conforming to the invention,

FIG. 2 shows the impact of the invention on the withdrawn power setpoints,

FIG. 3 shows a first example of the shape of the withdrawn powers setpoints following an additional withdrawal during a transition phase,

FIG. 4 illustrates a first example of establishment of the control logic allowing obtaining the shape of the setpoints of FIG. 3,

FIG. 5 shows the different steps of a first example of a method allowing obtaining the shape of the setpoints of FIG. 3,

FIG. 6 shows a second example of the shape of the power withdrawal setpoints following an additional withdrawal during a transition phase,

FIG. 7 illustrates a second example of establishment of the control logic allowing obtaining the shape of the setpoints of FIG. 6,

FIG. 8 shows the different steps of a second example of a method allowing obtaining the shape of the setpoints of FIG. 6,

FIG. 9 shows an architecture of an internal hybridization system of a turbine engine according to the prior art, and

FIG. 10 illustrates the power withdrawal setpoints associated with the architecture of the prior art.

### DESCRIPTION OF THE EMBODIMENTS

The principle of the invention relies on the limitation of the impacts of power withdrawal on the high-pressure (HP) and/or low-pressure (LP) shafts when changing the generation mode, by introducing a smoothing function for the power withdrawal setpoints while guaranteeing that the total withdrawn power allows the feeding of the electrical network of the turbine engine and the aircraft.

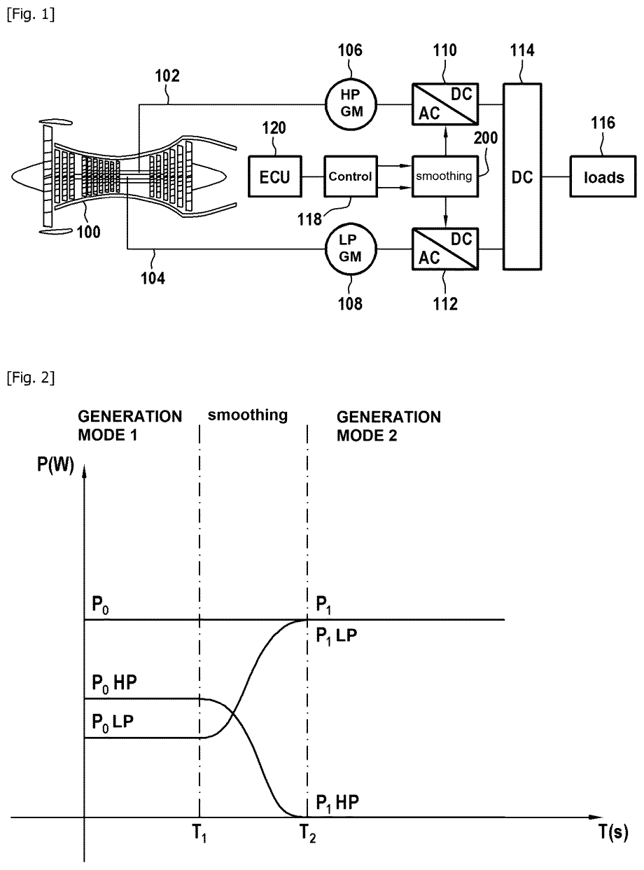

As illustrated in FIG. 1 (modules identical to those of the prior art are assigned the same reference symbols and are not described again), this smoothing function f(t) allowing a gentle transition between two generation modes is obtained by the addition of an adapter module 200 for the setpoints obtained from the ECU and destined for the electrical machines. This module is arranged between the control module 118 and the power converters 110, 112 associated with the electrical machines 106, 108 mounted on the high- and low-pressure shafts 102, 104.

FIG. 2 illustrates the power withdrawal setpoints during the transition phase (smoothing) conveying the change in generation mode, after integration of the smoothing function accomplished by the adapter module 200. It can be noted there that the passage from the first generation mode in which 60% of the power is withdrawn from the HP shaft and 40% of the power is withdrawn from the LP shaft, to the second generation mode in which 100% of the power is withdrawn from the LP shaft is no longer immediate, at a given time t₀ as in the prior art, but is distributed over a longer period (typically comprised between 1 and 10 seconds) between a time tᵢ and a time t₂ during which the power withdrawn from each shaft passes progressively (and not abruptly) from its current level in the first generation mode to its future level in the second generation mode, without modification of the total power consumed by the electrical network.

The smoothing function f(t) which provides this progressive increase is typically a linear function f(t)=Kt, K being a proportionality factor, or a first-order function of the f(t)=1−exp(−t/tau) type, tau being a time constant. These two preferred function types must not however be considered as limiting; a second-order function satisfying the transfer function f(p)=1/(p²/w²+2mp/w+1) in the Laplace domain, m being a damping coefficient>=1, can also be considered, likewise an application of these first- and second-order functions to the aforementioned linear function. More generally, any continuous or discrete bounded [0; 1] monotonic function with f(t₁)=0 and f(t₂)=1, can be suitable.

As mentioned previously, this transition phase not being immediate, the case must be considered where a power withdrawal demand arrives during this transitional phase where the regime has not yet been reached.

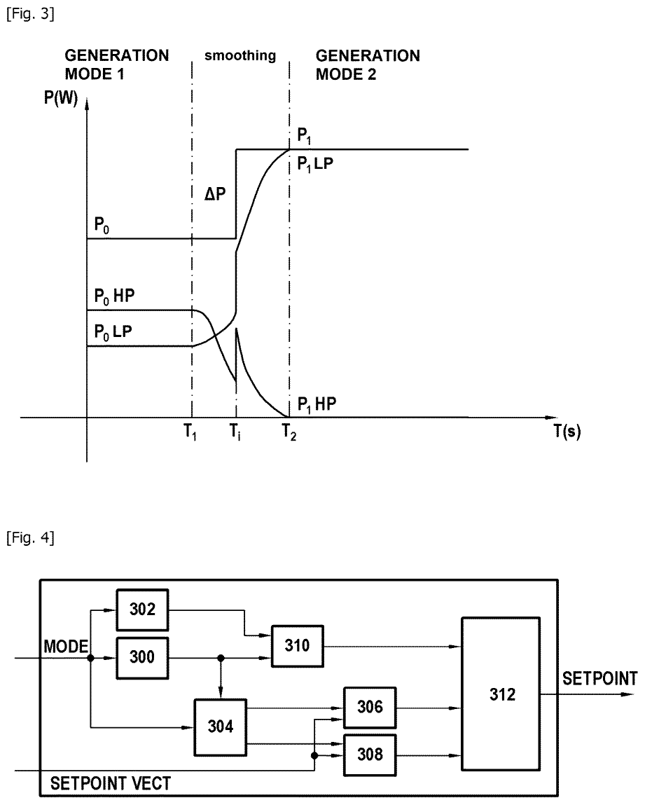

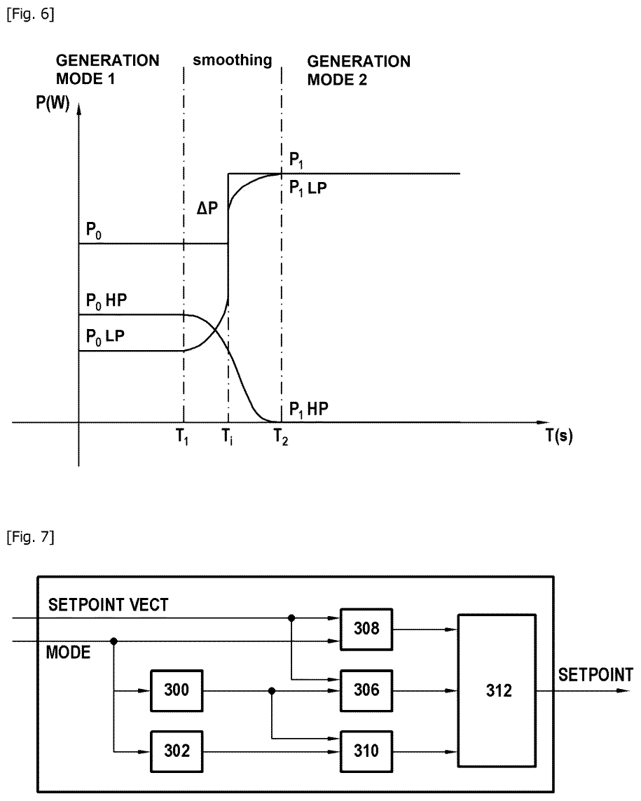

According to the invention, two sharing solutions are considered. The first, illustrated in FIGS. 3 to 5, in which the power demand difference is processed in the same manner as the initial power demand, i.e. the two modes pro rata, depending on the sharing function, while in the second, illustrated in FIGS. 6 to 8, the power demand difference uses the second generation mode. It will be noted that if there is no evolution of the demand during the transition, the two alternatives are equivalent.

In the first solution, it is therefore the case, when there is a load impact that operates during the transition, that the withdrawn power sharing which had been defined continues to be applied.

FIG. 3 shows the shape of the power setpoints obtained with this initial sharing. For example, if to deliver a total power P₀, the initial power sharing is 60% from the HP shaft and 40% from the LP shaft and it is desired to pass to 0% on the HP shaft and 100% on the LP shaft, and if, during the transition phase between time t₁ and time t₂, there is a modification of the power demands by the consumers at time tᵢ, for example an additional demand of 50% to arrive at a total power P₁ as illustrated, then in this case, the new power demand by the consumers will be withdrawn at the 60% level from the HP shaft and at 40% from the LP shaft at the point of application of the withdrawal change.

This solution is translated mathematically by the following equations:

P_{HP}=(1−ƒ(t))*P_{0HP}(t)+ƒ(t)*P_{1HP}(t)

P_{LP}=(1−ƒ(t))*P_{0LP}(t)+ƒ(t)*P_{1LP}(t)

With P₀ the power demand in the first generation mode (respectively from the HP shaft or the LP shaft) and P₁ the power demand in the second generation mode (respectively from the HP shaft or the LP shaft).

FIG. 4 illustrates the control logic implemented in the adapter module to satisfy this equation. It is organized conventionally around different functional blocks which will elaborate the current setpoint (setpoint) based on the selected generation mode (Mode) and the evolution of the setpoint (setpoint vect): a block 300 for detecting the mode change, a block 302 for inhibiting the transition, a block 304 for storage of the former and new modes, a block 306 for generating the former power setpoint, a block 308 for generating the new power setpoint, a block 310 for generating the transition and a block 312 for combining the former and new power setpoints.

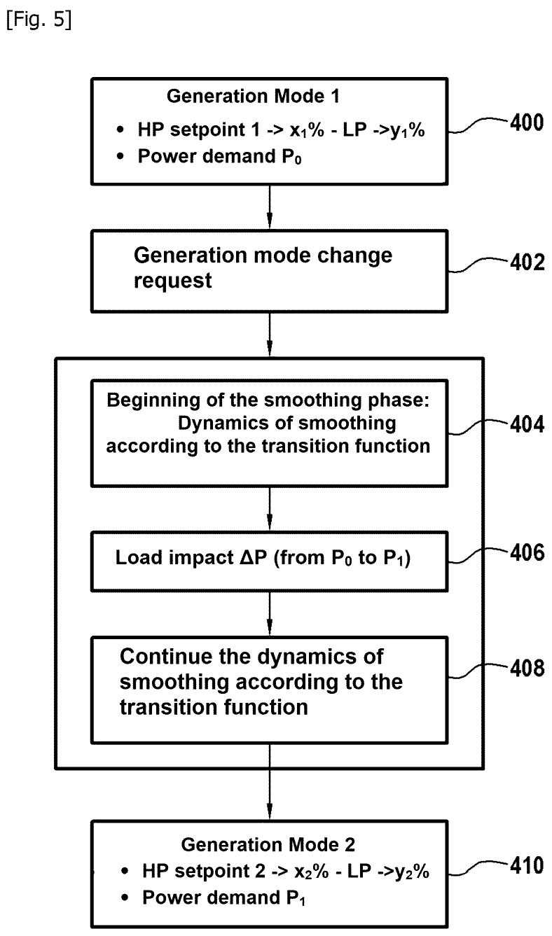

The different steps allowing passage from the first to the second generation mode are now illustrated in FIG. 5. In a first step 400, the power setpoint of the HP shaft is at x₁ % (for example 60%) of the power consumed and that of the LP shaft at y₁ % (for example 40%) of this power consumed, defining power demand in the first generation mode P₀. In a following step 402 at time t₁, a request for changing the generation mode in the power ratio is detected and the transition is then engaged by application of the smoothing function f(t) in a new step 404. In a following step 406, at time tᵢ, a load impact ΔP (P₁−P₀) is observed due to an additional demand to bring the power to the power demand in the second generation mode P₁, and this load impact is immediately fed back to the high- and low-pressure powers according to the initial power sharing. In the following step 408, the dynamics of the transition is resumed on the basis of the smoothing function until the end of the transition at time t₂ and obtaining the permanent regime at power P₁ in a power ratio of x₂ % for the high pressure and y₂ % for the low pressure in a final step 410.

In the second solution it is the case, when there is a load impact that operates during the transition (i.e. a withdrawn power setpoint change), that the power sharing that it is desired to attain following the desired change of generation mode is applied.

FIG. 6 shows the shape of the power setpoints obtained with this final sharing. For example if, in order to deliver a total power P₀, the initial power sharing is 60% from the HP shaft and 40% from the LP shaft and that it is desired to pass to 0% from the HP shaft and 100% from the LP shaft and if, during the transition phase, between time t₁ and time t₂, there is at time tᵢ a modification of the power demands of the consumers, for example an additional demand of 50% to arrive at a total power P₁ as illustrated, then in this case, the new power demand of the consumers will be withdrawn at the level of 0% on the HP shaft and 100% on the LP shaft until the permanent regime is reached.

This solution translates mathematically into the following equations:

P_{HP}=(1−ƒ(t))*P_{0HP}(t₁)+ƒ(t)*P_{1HP}(t₁)+P_{1HP}(t)−P_{1HP}(t₁)

P_{lP}=(1−ƒ(t))*P_{0LP}(t₁)+ƒ(t)*P_{1LP}(t₁)+P_{1LP}(t)−P_{1LP}(t₁)

With P₀ the power demand in the first generation mode (respectively from the HP shaft or the LP shaft), P₁ the power demand in the second generation mode (respectively from the HP shaft or the LP shaft) and t₁ the time of the mode change.

FIG. 7 illustrates the control logic implemented in the adapter module to satisfy this equation. It is organized conventionally around different functional blocks which will elaborate the current setpoint (setpoint) based on the generation mode (Mode) and the evolution of the setpoint (setpoint vect): the block 300 for detecting the mode change, the block 302 for inhibiting the transition, the block 306 for generating the former power setpoint, the block 308 for generating the new power setpoint, the block 310 for generating the transition and the block 312 for combining the former and new power setpoints.

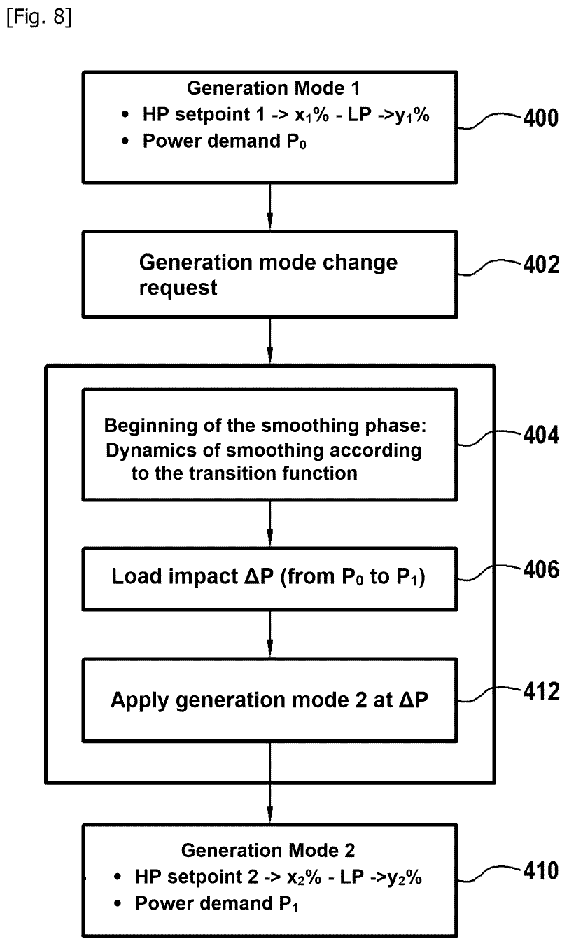

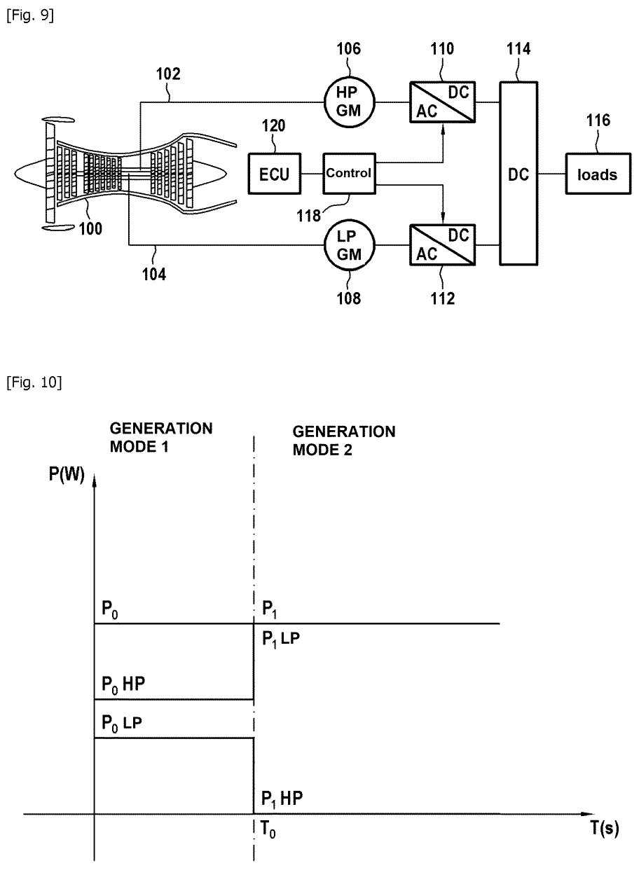

The different steps allowing passage from the first to the second generation mode are now illustrated in FIG. 8. In the first step 400, the power setpoint from the HP shaft is x₁ % (for example 60%) of the power consumed and that from the LP shaft is y₁ % (for example 40%) of this power consumed, defining a power demand P₀. In the following step 402, at time t₁, a request for a generation mode change in the power ratio is detected and the transition phase is then engaged in application of the smoothing function f(t) in the following step 404. In step 406, at time tᵢ, a load impact ΔP (P₁−P₀) is observed due to an additional demand to bring the total power to the power demand in the second generation mode P₁ and this load impact is immediately fed back to the high- and low-pressure powers according to the final power sharing. In the following step 412, the dynamics of the transition is resumed on the basis of the smoothing function until the end of the transition at time t₂ and obtaining the permanent regime at the power demand P₁ in a power ratio of x₂ % for high pressure and y₂ % for low pressure in the final step 410.

It will be noted that the invention finds application in the internal hybridization of a turbine engine regardless of the number of electrical machines mounted on the propulsion system and the type of turbine engine, such as a hybrid turbofan, a hybrid turboprop or a hybrid helicopter turbine engine.

1. A method for managing power transitions between a first generation mode and a second generation mode in a turbine engine having a high-pressure shaft from which high-pressure power is withdrawn and a low-pressure shaft from which low-pressure power is withdrawn, the first generation mode corresponding to a first power sharing between the high-pressure power and the low-pressure power and the second generation mode corresponding to a second power sharing, different from the first, between the high-pressure power and the low-pressure power, the sum of the high- and low-pressure powers withdrawn in each generation mode defining the same total power, characterized in that the transition between the first generation mode and the second generation mode occurs during a predetermined period without modification of the total power and while applying the same smoothing function f(t) to the withdrawal of both the high-pressure power and of low-pressure power.

2. The method for managing power transitions according to claim 1, wherein the smoothing function f(t) is a continuous or discrete bounded [0; 1] monotonic function with f(t₁)=0 and f(t₂)=1.

3. The method for managing power transitions according to claim 2, wherein the smoothing function f(t) is a linear function f(t)=Kt, K being a proportionality factor, or a first-order function of the f(t)=1−exp(−t/tau) type, tau being a time constant.

4. The method for managing power transitions according to claim 1, wherein the predetermined period is comprised between 1 and 10 seconds.

5. The method for managing power transitions according to claim 1, wherein when a load impact corresponding to an additional withdrawal of power occurs during the transition, this additional withdrawal is carried out at the time of the impact according to the first power sharing or according to the second power sharing, the smoothing function f(t) remaining applied upstream of this moment from a beginning of the transition and downstream of this moment until an end of the transition.

6. The method for managing power transitions according to claim 5, wherein the additional withdrawal of power P carried out from each of the high- or low-pressure shafts according to the first power sharing satisfies the following equation:
P=(1−ƒ(t))*P₀(t)+ƒ(t)*P₁(t), P₀ being the power required in the first generation mode and P₁ the power required in the second generation mode.

7. The method for managing power transitions according to claim 5, wherein the additional withdrawal of power P carried out from each of the high- and low-pressure shafts according to the second power sharing satisfies the following equation:
P=(1−ƒ(t))*P₀(t₁)+ƒ(t)*P₁(t₁)+P₁(t)−P₁(t₁), P₀ being the power required in the first generation mode, P₁ the power required in the second generation mode and t₁ the time of the mode change.

8. A turbine engine having a high-pressure shaft from which high-pressure power is withdrawn and a low-pressure shaft from which low-pressure power is withdrawn, a first generation mode corresponding to a first power sharing between the high-pressure power and the low-pressure power and a second generation mode corresponding to a second power sharing, different from the first, between the high-pressure power and the low-pressure power, the sum of the high- and low-pressure powers withdrawn in each generation mode defining the same total power, characterized in that the transition between the first generation mode and the second generation mode occurs during a predetermined period without modifying the total power and while applying the same smoothing function f(t) to the withdrawal both of high-pressure power and of low-pressure power.

9. The turbine engine according to claim 8, also comprising an adapter module configured to generate the smoothing function f(t) and arranged between a control module receiving power setpoints from an ECU and power converters associated with electrical machines mounted on the high and low-pressure shafts.

10. The turbine engine according to claim 9, constituted as an aeronautical turbine engines such as a hybrid turbofan, a hybrid turboprop or a hybrid helicopter turbine engine.
